(19) United States
(12) Patent Application Publication
(10) Pub. No.: US 2026/0086495 A1
(43) Pub. Date: Mar. 26, 2026

(54) IMAGE FORMING APPARATUS

(71) Applicant: CANON KABUSHIKI KAISHA, Tokyo (JP)

(72) Inventors: SHINYA NODA, Shizuoka (JP); KENJI ABE, Shizuoka (JP)

(21) Appl. No.: 19/316,695

(22) Filed: Sep. 2, 2025

(30) Foreign Application Priority Data
Sep. 26, 2024 (JP) 2024-167150

(51) Int. Cl. G03G 21/16; G03G 15/16

(52) U.S. Cl. CPC G03G 21/1638; G03G 15/1675; G03G 21/1619; G03G 21/168; G03G 2221/1642; G03G 2221/1675; G03G 2221/1687; G03G 2221/169

(57) ABSTRACT

An image forming apparatus includes an apparatus main body having a receiving portion on a conveying path, an open/close unit movable between open and close positions, a roller located on the conveying path when the open/close unit is closed, a pressure applying unit applying pressure to the roller, and a separation unit movable between first and second positions. When at the first position, the roller contacts the receiving portion with pressure from the pressure applying unit. When at the second position, the roller is separated from the receiving portion. A switching device switches the separation unit's position, controlled by a control unit. An open/close detecting unit detects the open/close unit's state. If the separation unit is at the second position and the open/close unit is detected at the open position, the control unit controls the switching device to move the separation unit to the first position.

### BACKGROUND

### Field of the Technology

The present disclosure relates to an image forming apparatus.

### Description of the Related Art

An image forming apparatus has a configuration to convey a recording material which is pressed by a plurality of roller pairs. For example, in a transfer portion which transfers a developer image from a photosensitive drum or an intermediate transfer member onto a recording material, or in a conveying roller pair which conveys a recording material on a conveying path, a driver roller which is rotated by a drive force received from a drive source, a driven roller which faces the driver roller via a conveying path and rotates following the driver roller, bearings which rotatably support each of the rollers, and a pressing member which presses the driven roller to the driver roller at a predetermined contact force, are provided.

In the transfer portion, a configuration having an open/close door, which can be freely opened or closed a space inside a main body of an image forming apparatus, is known, where as the driver roller a counter roller is provided to the main body side, and as the driven roller a transfer roller is provided to the open/close door side (Japanese Patent Application Laid-Open No. 2009-288376).

In Japanese Patent Application Laid-Open No. 2009-288376, a state where a secondary transfer nip is formed between the transfer roller and the counter roller and a state where the secondary transfer nip is released are switched over by the movement of the transfer roller.

In a case where an image forming apparatus, where the apparatus main body has a receiving portion and an open/close unit which can open or close the apparatus main body, includes a roller and a pressure applying unit which presses the roller to the receiving portion, the force of a pressing member may, in some cases, become a resistance to close the open/close unit.

### SUMMARY

The present disclosure provides a technique to suppress the force of the pressing member from becoming a resistance when closing the open/close unit.

The present disclosure provides an image forming apparatus forming an image on a recording material which is conveyed through a conveying path, the image forming apparatus comprising:
an apparatus main body including a receiving portion located in the conveying path;
an open/close unit configured to be movable between an open position at which the conveying path is exposed to outside and a close position at which the conveying path is covered;
a roller provided to the open/close unit and configured to be located in the conveying path when the open/close unit is closed;
a pressure applying unit provided to the open/close unit and configured to apply pressure to the roller;
a separation unit provided to the apparatus main body, and configured to be movable between a first position and a second position, such that the roller contacts with the receiving portion and force of the pressure applying unit is received by the receiving portion in a case where the separation unit is at the first position, and the roller is held at a position separated from the receiving portion against the force in a case where the separation unit is at the second position;
a switching device configured to switch the position of the separation unit between the first position and the second position;
a control unit configured to control the switching device; and
an open/close detecting unit configured to detect an open/close state of the open/close unit, wherein
in a case where detection is made that the separation unit is at the second position and the open/close unit is at the open position, the control unit controls the switching device so that the separation unit is moved from the second position to the first position.

Features of the present disclosure will become apparent from the following description of embodiments with reference to the attached drawings. The following description of embodiments are described by way of example.

### BRIEF DESCRIPTION OF THE DRAWINGS

FIG. 1 is a cross-sectional view of an image forming apparatus of Embodiment 1.

FIG. 2 is a cross-sectional view of a state where an open/close door of Embodiment 1 is open.

FIG. 3 is a perspective view of an intermediate transfer unit of Embodiment 1.

FIG. 4 is a perspective view of a roller separation mechanism of Embodiment 1.

FIG. 5 is a partial perspective view of a transfer unit of Embodiment 1.

FIG. 6 is a cross-sectional view of the image forming apparatus of Embodiment 1.

FIG. 7A and FIG. 7B are perspective views of a roller separation mechanism of Embodiment 1.

FIG. 8 is a cross-sectional view depicting an operation to close the open/close door of Embodiment 1.

FIG. 9 is a cross-sectional view depicting an operation to close the open/close door of Embodiment 1.

FIG. 10A and FIG. 10B are perspective views of a roller separation mechanism of Embodiment 2.

FIG. 11 is a cross-sectional view of an image forming apparatus of Embodiment 3.

FIG. 12 is a cross-sectional view of the image forming apparatus of Embodiment 3.

### DESCRIPTION OF THE EMBODIMENTS

Embodiments of the present invention will now be described in detail using examples with reference to the drawings. Dimensions, materials, shapes, relative positions and the like of the composing elements described in the embodiments may be changed appropriately depending on the configuration and various conditions of an apparatus to which the present invention is applied. In other words, the following embodiments are not intended to limit the scope of the invention thereto.

### Embodiment 1

### General Description of Image Forming Apparatus

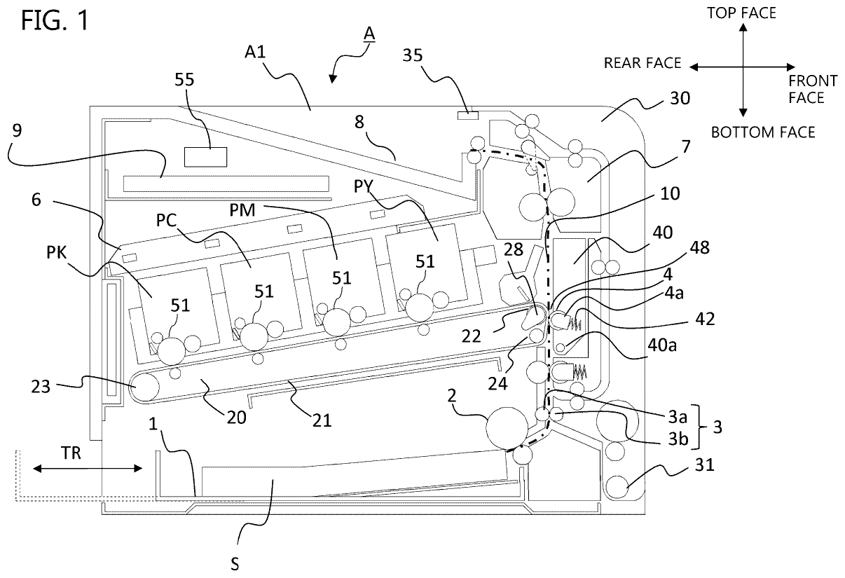

FIG. 1 is a cross-sectional view of a color electrophotographic image forming apparatus A using a laser beam system in Embodiment 1. The image forming apparatus A includes: a paper feeding cassette 1, which is provided horizontally to a lower portion of the apparatus in the vertical direction, to load recording materials S; an intermediate transfer unit 20 which is provided above the paper feeding cassette 1; four process cartridges (PY, PM, PC, PK) supporting different colors respectively, provided above the intermediate transfer unit 20 side-by-side; and a laser scanner unit 6 which is optical means provided above the process cartridges P.

The paper feeding cassette 1 can move inside and outside the apparatus main body A1 in the arrow TR direction, and the user can refill the recording material S when the paper feeding cassette is drawn outside the apparatus main body. The recording material S of the paper feeding cassette 1 is conveyed by a paper feeding roller 2. The conveyed recording material S passes through a registration unit constituted of a registration roller pair 3, where deviation of the tips of the recording materials in the conveying direction is corrected, and the recording material S is conveyed to a nip between a transfer roller 4 of the secondary transfer unit 48 and a counter roller 22. Any number of conveying rollers may be provided to a conveying path 10.

The laser scanner unit 6, on the other hand, writes an electrostatic latent image on a photosensitive drum 51, which is an image bearing member inside each process cartridge P, based on the image data. The four process cartridges P are provided in a line in the sequence of yellow PY, magenta PM, cyan PC and black PK, and constitute four-color image forming stations. Toner images formed by the four-color image forming stations are primary-transferred and superimposed on an intermediate transfer belt 21, whereby a full color toner image is formed on the intermediate transfer belt 21.

Then the toner image on the intermediate transfer belt 21 is transferred to the recording material S which was conveyed to the nip of the secondary transfer unit 48, whereby a full color toner image is formed on the recording material at a predetermined position. The recording material S, on which the toner image was transferred, is conveyed to a fixing unit 7, and heated and pressed by a fixing nip, whereby the toner image is fixed to the surface of the recording material. Then the recording material S is discharged onto a discharging tray 8 provided to an upper portion of the apparatus.

As described above, in the image forming apparatus A of Embodiment 1, the paper feeding cassette 1 is provided to a lowest level in the vertical direction, and the conveying path 10 (indicated by a dashed line) to convey the recording material S in an approximately vertical direction, is formed along the front face (right side in FIG. 1) of the image forming apparatus A. While the recording material S passes through the conveying path 10, the image is recorded via a registration roller pair 3, the secondary transfer unit 48 and the fixing unit 7, then the recording material S is discharged to the discharging tray 8 provided to the highest portion.

In FIG. 1, an open/close door 30 is provided to the right of the conveying path 10 of the recording material S, and is opened/closed with a shaft 31 as the support. The open/close door 30 is an open/close unit shaft-supported by the apparatus main body A1. The open/close door 30 is movable between an open position where the conveying path 10 is exposed to the outside, and a close position where the conveying path 10 is covered. In the case of the recording material S becoming jammed on the conveying path, the open/close door 30 can be opened, so as to release the conveying path 10 and remove the jammed recording material S.

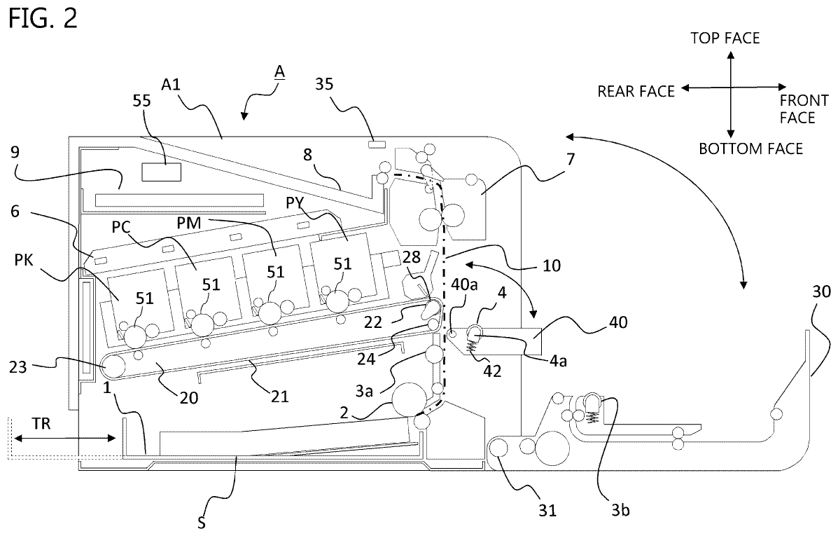

FIG. 2 indicates a state where the open/close door 30 is opened. The open/close door 30 holds a driven roller 3b of the registration roller pair 3, so that when the open/close door 30 is opened, the registration roller nip is released and the jammed recording material S can be removed from the conveying path 10 more easily. The transfer roller 4 is a roller supported by a transfer frame 40 (frame unit). The transfer roller 4 is rotatable and supported so as to be slidable toward the intermediate transfer belt 21. The transfer frame 40 is a unit that is rotatable around a shaft 40a, which is different from that of the open/close door 30, and opens or closes the transfer nip interlocking with the opening/closing of the open/close door 30.

The image forming apparatus A includes a door switch 35, which is an open/close detecting unit that detects the open/close state of the open/close door 30. When the open/close door 30 is opened around a shaft 31 located at the lower right of the main body, the open/close door 30 is separated from the door switch 35, whereby opening of the open/close door 30 is detected. Specifically, the state of the signal outputted from the door switch 35 (hereafter signal state) is different depending on whether the open/close door 30 is opened or closed. The signal state of the door switch 35 is switched, for example, between ON and OFF, or between High and Low, depending on the open/close state of the open/close door 30. The signal of the door switch 35 is sent to a control board 9 of the image forming apparatus A, and is used for controlling the apparatus. The control board 9 is a control unit to control each composing element of the image forming apparatus A. For example, the control board 9 can perform scanning of the laser scanner unit 6 based on the image data received from an external apparatus, timing control of image formation at each image forming station and conveying of the recording material S, detection of the open/close state of the open/close door 30, and notification to the user.

### Intermediate Transfer Unit

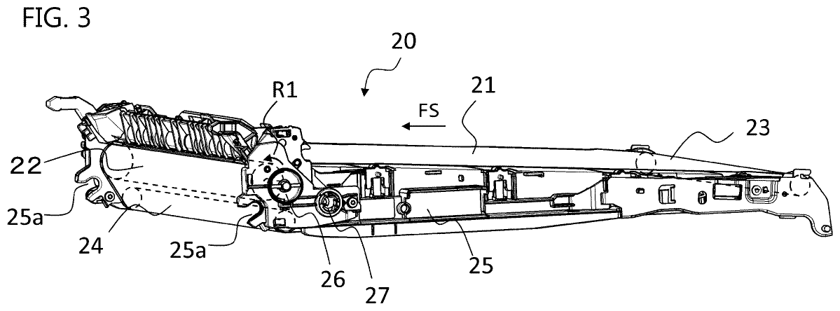

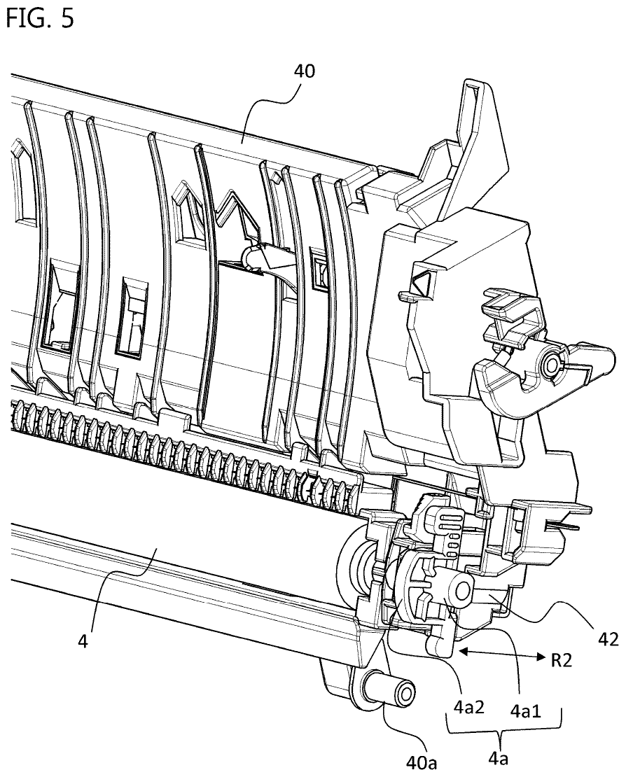

FIG. 3 is a perspective view of the intermediate transfer unit 20. The intermediate transfer unit 20 consists of the counter roller 22, a tension roller 23, and an assist roller 24 round which the intermediate transfer belt 21 passes. The counter roller 22, the tension roller 23, and the assist roller 24 are rotatably supported by an intermediate transfer frame 25. When the open/close door 30 is opened, the user can attach or detach this intermediate transfer unit 20 to/from the image forming apparatus A. The intermediate transfer unit 20 is positioned within a frame (not illustrated) of the image forming apparatus A by contacting the rotation shaft of the counter roller 22, which is a rotating member. In the intermediate transfer frame 25, a groove 25a, to slidably support a protruding portion 4a1 (see FIG. 5) of a transfer bearing 4a of the transfer roller 4, is formed.

A drive coupling 26, to drive the intermediate transfer belt 21, is fixed to the rotation shaft of the counter roller 22. The drive force from a motor 55, which is a drive source provided to the apparatus main body A1, is transferred to the counter roller 22 through the drive coupling 26 via a coupling on the main body side, whereby the counter roller 22 is rotated (arrow R1). By this rotation, the surface of the intermediate transfer belt 21 moves in the arrow FS direction at a predetermined speed. The motor 55 is a drive source to generate a power to rotate various rotating members in the apparatus. A number of motors 55 is not limited to 1, and a plurality of drive sources may be provided in accordance with the rotating members that are in use. The drive force from the motor 55 (drive source) is transferred to the driven member via transfer members, such as a coupling member, gears, and a belt.

In the intermediate transfer unit 20 of this configuration, the positioning and transfer of the drive force are performed by the rotation shaft of the counter roller 22, and the drive coupling 26 and the coupling on the main body side can be aligned at high accuracy. A separation coupling 27 is provided near the drive coupling 26. A drive force from a drive train (not illustrated), which is different from the drive coupling 26, is transferred to the separation coupling 27.

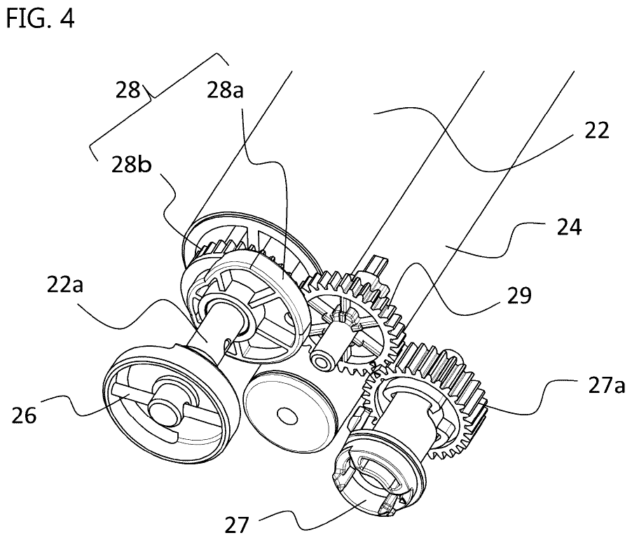

Inside the intermediate transfer frame 25, a gear 27a is provided coaxially with the separation coupling 27 (see FIG. 4). Further, inside the intermediate transfer frame 25, a separation cam 28 (separation unit) is supported on the rotation shaft of the counter roller 22, so as to be rotatable around the rotation shaft 22a. In the separation cam 28, a cam 28a, which can be contacted with/separated from a contacted surface 4a2 of a transfer bearing 4a, and a gear 28b are integrated side-by-side in the rotation shaft direction. The gear 27a and the gear 28b are linked via an intermediate gear 29, so as to transfer the rotation force from the separation coupling 27 to the gear 28b, whereby the separation cam 28 is rotated. The counter roller 22 can contact with the inner periphery of the intermediate transfer belt 21, and the intermediate transfer belt 21 can contact with the recording material S which is conveyed on the conveying path 10.

### Transfer Unit

FIG. 5 is a partial perspective view of a transfer unit (secondary transfer unit 48) focusing on a part of the transfer frame 40. In the transfer frame 40, the transfer bearing 4a is supported to be slidable in the arrow R2 direction, and a transfer spring 42 (pressure applying unit) is provided between the transfer frame 40 and the transfer bearing 4a. The transfer spring 42 is a biasing member which can be compressed and decompressed, and presses the transfer bearing 4a and generates a predetermined pressing force to move the transfer roller 4 (secondary transfer roller) to the counter roller 22. The transfer roller 4 is rotatably supported by the transfer bearing 4a, so as to be supported in the transfer frame 40 in a slidable and rotatable state. The transfer roller 4 is configured to be detachably attached to the image forming apparatus A, since the transfer roller 4, together with the transfer bearing 4a, can be detached from the transfer frame 40.

When the open/close door 30 is at the open position, the transfer roller 4 is separated from the conveying path 10, and when the open/close door 30 is at the close position, the transfer roller 4 is positioned on the conveying path 10. When the open/close door 30 is closed, the portion receiving force from the transfer roller 4 is called the “receiving portion”. The receiving portion is located in the conveying path 10. The counter roller 22 is located at a position where the force from the transfer roller 4 is received via the conveying path 10 and the intermediate transfer belt 21. Therefore the receiving portion includes the counter roller 22 and a part of the intermediate transfer belt 21 sandwiched between the counter roller 22 and the transfer roller 4.

The transfer bearing 4a includes a protruding portion 4a1 which is coaxial with the rotation shat of the transfer roller 4. The protruding portion 4a1 engages with a groove 25a of the intermediate transfer frame 25 illustrated in FIG. 3, whereby the transfer roller 4 is positioned with respect to the intermediate transfer unit 20 in a direction orthogonally intersecting with the sliding direction.

As illustrated in FIG. 2, in Embodiment 1, the transfer roller 4 presses the intermediate transfer belt 21 by an elastic force of the transfer spring 42 when the open/close door 30 is opened. Then the transfer frame 40, which is below the transfer roller 4, rotates with respect to the image forming apparatus A, around the rotation shaft 40a, which is different from the shaft 31 of the open/close door 30. Due to the balance of the center of gravity of the transfer unit, the transfer roller 4 rotates in a direction away from the intermediate transfer belt 21, and opens the transfer nip. Thereby even if the recording paper is jammed at the transfer portion, the recording material S can be easily removed.

### Roller Separation Mechanism

When the image forming apparatus A is conveying a recording material S, the transfer roller 4 is pressed against the intermediate transfer belt 21 by the transfer spring 42. When the transfer roller 4 is pressed, about a 2 to 8 Kgf force from both ends in total is applied to the intermediate transfer belt 21. Hence if the state where the transfer roller 4 is pressed against the intermediate transfer belt 21 continues for a long time, a creep deformation may be generated in the intermediate transfer belt 21 or the transfer roller 4. To prevent this state, a roller separation mechanism 44 is provided to the image forming apparatus A, so that the transfer roller 4 is separated from the intermediate transfer belt 21 when no operation is instructed even if a predetermined time has elapsed. The roller separation mechanism 44 of Embodiment 1 includes at least the separation cam 28.

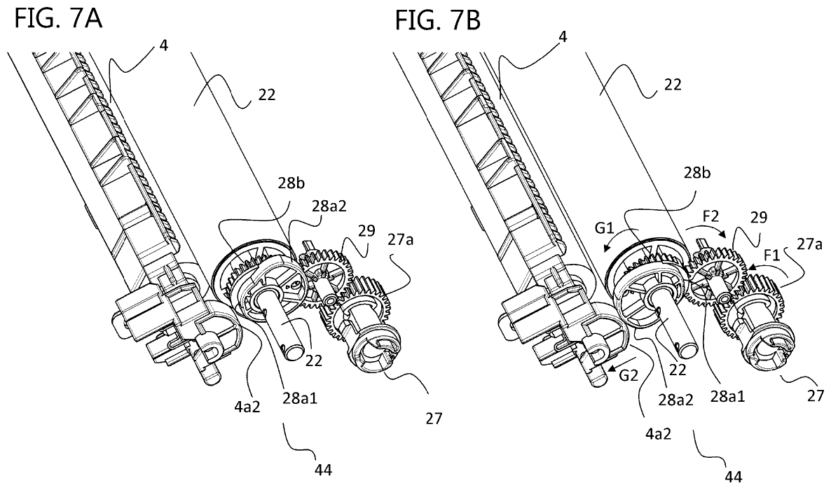

FIG. 7A is a state where the roller separation mechanism 44 is separating the transfer roller 4 from the intermediate transfer belt 21. This is a state where the image forming operation is being performed, or where the time that elapsed from the previous image forming operation is within a predetermined time. In this case, the cam 28a of the separation cam 28 is stopping at a position where a small R portion 28a1 is facing a contacted surface 4a2 of the transfer bearing 4a. This position is called a “first position”. When the separation cam 28 is at the first position, the transfer roller 4 is in contact with the intermediate transfer belt 21 at a predetermined pressing force, as illustrated in FIG. 1, and this state is called a “contact state” of the roller separation mechanism 44. The separation cam 28 is rotatably supported by the counter roller 22, hence even if the counter roller 22 is rotated by the drive force received from the drive coupling 26, the separation cam 28 remains stopped, and the position thereof with respect to the transfer bearing 4a does not change. As a result, the roller separation mechanism 44 can maintain the contact state even during the image forming operation.

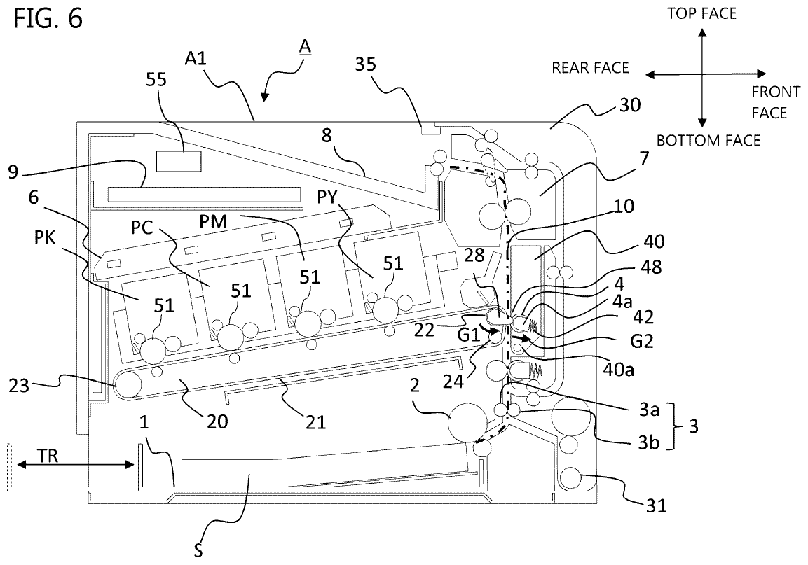

When no operation is instructed, even if the predetermined time has elapsed from the stop of the image forming operation, the control board 9 sends a driving instruction to the motor 55, which is a driving source of the roller separation mechanism 44, so as to switch the roller separation mechanism 44 to the separation state illustrated in FIG. 7B. This change of state will be described with reference to FIG. 6 and FIG. 7B. When the separation coupling 27 rotates, the separation cam 28 is rotated via the rotation of the gear 27a (arrow F1), rotation of the gear 29 (arrow F2), and rotation of the gear 28b (arrow G1), and is moved from the first position to the second position. The separation cam 28 has a surface which includes the small R portion 28a1 and a large R portion 28a2, and this surface extends in a direction intersecting orthogonally with the rotation shaft. The control board 9 moves the separation cam 28 to the second position, so that the large R portion 28a2 contacts with the contacted surface 4a2 of the transfer bearing 4a.

As illustrated in FIG. 6 and FIG. 7B, in a state where the large R portion 28a2 contacts with the contacted surface 4a2 of the transfer bearing 4a, the transfer bearing 4a pushes the transfer spring 42 (arrow G2), and the transfer roller 4 moves to a position separated from the intermediate transfer belt 21. In this separation state, the contact between the transfer roller 4 and the intermediate transfer belt 21 is cleared, hence the generation of creep deformation in the intermediate transfer belt 21 and the transfer roller 4 can be prevented. As described above, the control board 9 controls the switching device, including the motor 55 and the gears 27a, 28b and 29, and switches the position of the separation cam 38 (separation unit) between the first position and the second position, whereby the contact state and the separation state of the transfer roller 4 and the counter roller 22 can be switched.

When the image forming apparatus A is instructed to performing the image forming operation in the separation state, the control board 9 switches the roller separation mechanism 44 to the contact state, as illustrated in FIG. 7A and FIG. 1, so that the transfer roller 4 contacts the intermediate transfer belt 21. In this state, the image forming operation can be performed.

### Closing Operation of Open/Close Door

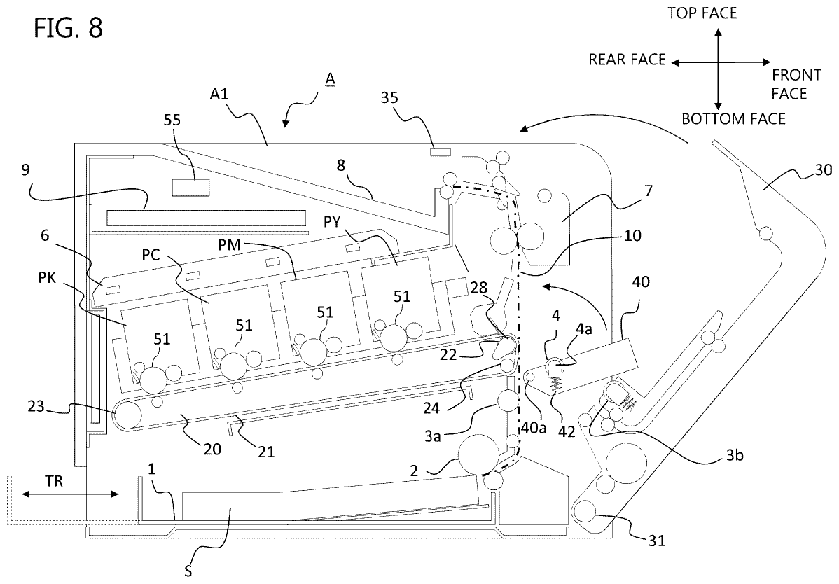

An operation of the roller separation mechanism 44 when the open/close door 30 is closed will be described. When the open/close door 30 in the open state is closed, the open/close door 30 rotates around the shaft 31 at the lower side of the apparatus, and contacts with the transfer frame 40 in the middle of the closing operation (see FIG. 8). When the closing operation continues further, the transfer frame 40, pressed by the transfer roller 4, rotates around the rotation shaft 40a. If the closing operation continues further, the protruding portion 4a1 of the transfer bearing 4a engages with the groove 25a of the intermediate transfer frame 25, whereby the vertical position of the transfer roller 4, with respect to the intermediate transfer unit 20, is restricted. If the closing operation continues further, the transfer roller 4 approaches the intermediate transfer belt 21 by the rotation of the transfer frame 40 interlocking with the rotation of the open/close door 30. In other words, the transfer frame 40 and the open/close door 30 can be moved relative to each other, and once contacted in the middle of the closing operation of the open/close door 30, the transfer frame 40 and the open/close door 30 are interlocked and rotate in the same direction, and the open/close door 30 is closed.

When the roller separation mechanism 44 is in the contact state (see FIG. 7A), the small R portion 28a1 of the separation cam 28 faces the contacted surface 4a2 of the transfer bearing 4a. Therefore the separation cam 28 and the transfer bearing 4a do not contact, and the transfer roller 4 contacts with the intermediate transfer belt 21. Then the transfer spring 42 is compressed between the transfer belt 21 and the transfer frame 40 by the closing operation of the open/close door 30. When the open/close door 30 and the transfer frame 40 are completely closed (see FIG. 1), the transfer spring 42 press-contacts the transfer roller 4 to the intermediate transfer belt 21 at a predetermined pressing force. Here the resistance generated when the open/close door 30 is closed by the transfer spring 42 is a reaction force of the pressing force generated when the transfer roller 4 conveys the recording material S, which is press-contacted with the intermediate transfer belt 21. When the open/close door 30 is completely closed, the edge of the open/close door 30 contacts with the door switch 35. Thereby the door switch 35 detects that the open/close door 30 is closed. In other words, the signal state of the door switch 35 changes, and closing of the open/close door 30 is notified to the control board 9. As a result, the control board 9 determines that the image forming apparatus A is in the operable state.

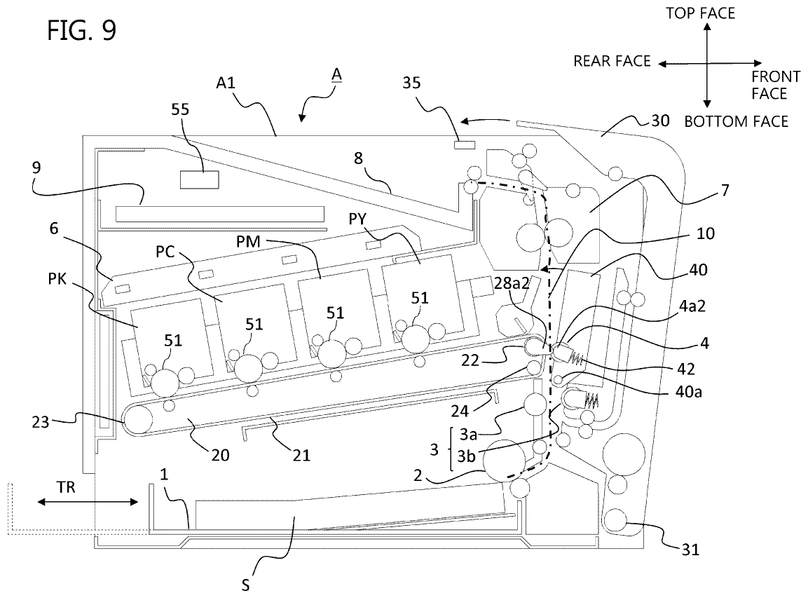

If the open/close door 30 is closed when the roller separation mechanism 44 is in the separation state, the contacted surface 4a2 of the transfer bearing 4a contacts the large R portion 28a2 of the separation cam 28 before the transfer roller 4 contacts with the intermediate transfer belt 21, as illustrated in FIG. 9. When the open/close door 30 is completely closed, the contacted surface 4a2 of the transfer bearing 4a is pushed by the large R portion 28a2 of the separation cam 28, the transfer bearing 4a compresses the transfer spring 42 even more than in the contact state (see FIG. 6 and FIG. 7B). In other words, in a state where the open/close door 30 is closed, the deformation amount of the transfer spring 42 in the separation state is larger than the deformation amount of the transfer spring 42 in the contact state. Therefore the transfer frame 40 receives a larger reaction force than the case of the contact state, and energizes the open/close door 30 in the opening direction using this reaction force. When the roller separation mechanism 44 is in the separation state, the reaction force of the transfer spring 42, which is generated when the open/close door 30 is completely closed, becomes larger than in the contact state, hence the operating force to close the open/close door 30 increases.

In the case where the roller separation mechanism 44 is in the separation state, increasing the operating force like this may interrupt operation of the user closing the open/close door 30. If the open/close door 30 is not completely closed, the door switch 35 does not detect closing of the open/close door 30, and the control board 9 notifies the user, via the operation panel or the like, with a message that the “open/close door 30 is open”. The user thinks that the open/close door 30 is closed, but the image forming apparatus A prompts the user to close the open/close door 30, hence the user may suspect a malfunction of the image forming apparatus A.

### Processing of Embodiment 1

To prevent this state, the following processing is performed in Embodiment 1. When the roller separation mechanism 44 is in the separation state illustrated in FIG. 7B, and the open/close door 30 is opened and the door switch 35 detects the opening of the open/close door 30 in this state, the control board 9 instructs to start driving to the motor 55, which is the drive source of the separation coupling 27, so as to move the roller separation mechanism 44 to the contact state illustrated in FIG. 7A. Specifically, based on the change of the signal state of the door switch 35 caused by opening of the open/close door 30, the control board 9 instructs to start driving to the motor 55, which is the drive source of the separation coupling 27, so as to move the roller separation mechanism 44 to the contact state illustrated in FIG. 7A. If the open/close door 30 is opened when the roller separation mechanism 44 is in the contact state, the contact state is maintained. In other words, in Embodiment 1, the roller separation mechanism 44 is in the contact state when the open/close door 30 is in the open state.

Thereby even when the open/close door 30 is closed, the roller separation mechanism 44 is in the contact state, and an increase in the operating force of the open/close door 30 can be suppressed.

The reason why the roller separation mechanism 44 sets the transfer roller 4 to the separation state is to prevent creep deformation of the intermediate transfer belt 21 and the transfer roller 4, which may be generated when the roller separation mechanism 44 remains in the contact state for a long time. Therefore in Embodiment 1, such problems as creep deformation are not generated, even if the roller separation mechanism 44 is changed to the contact state when the open/close door 30 is in the open state.

The roller separation mechanism 44 is inside the intermediate transfer unit 20, and the drive train to drive the separation coupling 27 is also inside the image forming apparatus. Hence even if the roller separation mechanism 44 is driven after detecting the opening of the open/close door 30, the user never touches the rotating portion of the gears and the separation cam 28. Therefore the user is never injured even if the rotating portion is touched, and there are no safety concerns.

It is preferable that the timing to switch to the contact state is set to immediately after the door switch 35 detects the opening of the open/close door 30, then the driving sound of the gears and the like is obscured by the operating sounds of the open/close door 30. In other words, it is preferable that the roller separation mechanism 44 is switched to the contact state after the signal sate of the door switch 35 is changed by opening of the open/close door 30 and before the open/close door 30 reaches the open state.

In the description of Embodiment 1, the transfer frame 40 and the open/close door 30 are rotated around the rotation shafts different from each other. However the above mentioned functions and effects can be implemented even in a configuration where the transfer frame 40 is held by the open/close door 30 and is moved thereby, or by a configuration where the transfer roller 4 is supported by the open/close door 30.

As mentioned above, such problems as deformation are not generated when the open/close door 30 is open, even if the roller separation mechanism 44 is in the contact state, but in the case where the user closes the open/close door 30, such problems as deformation may be generated if the roller separation mechanism 44 is in the contact state for a long time. Therefore the control board 9 switches the roller separation mechanism 44 to the separation state if a predetermined time elapses after closing the open/close door 30 without the image forming operation or the like being performed.

### Embodiment 2

In Embodiment 1, the roller separation mechanism 44 uses the separation cam, which is rotatably provided to the counter roller 22, as the pressing member. In Embodiment 2, on the other hand, the roller separation mechanism 45, in which a slider is used as the pressing member, will be described. Contents already described in Embodiment 1 will be omitted.

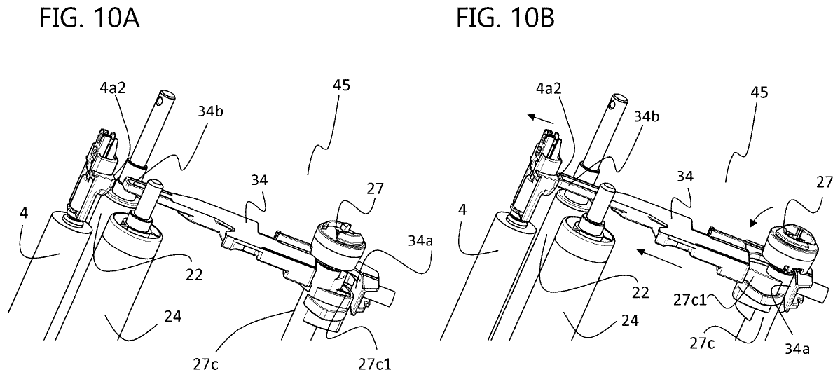

In the separation coupling 27 of Embodiment 2, a cam 27c is provided inside the intermediate transfer frame 25, as illustrated in FIG. 10A and FIG. 10B. A protruding portion 27c1 is provided in the cam 27c at a position distant from the rotation center. Further, inside the intermediate transfer frame 25, a slider 34 is provided. One end of the slider 34 has a recessed portion 34a which engages with the cam 27c, and the slider 34 is slidably supported by the intermediate transfer frame 25. The other end of the slider 34 has a pressing unit 34b, which slides between the shaft of the counter roller 22 and the shaft of the assist roller 24.

When the control board 9 drives the separation coupling 27, the cam 27c rotates. As illustrated in FIG. 10A, when the protruding portion 27c1 of the cam 27c is on the opposite side of the counter roller 22, the recessed portion 34a is engaged with the cam 27c, hence the slider 34 is at a position within the intermediate transfer frame 25. Here the pressing unit 34b of the slider 34 is separated from the contacted surface 4a2 of the transfer bearing 4a, and the transfer roller 4 press-contacts with the intermediate transfer belt 21 by the spring force of the transfer spring 42. In Embodiment 2, this state is called a “contact state”.

On the other hand, when the cam 27c rotates and the protruding portion 27c1 moves to the counter roller, as illustrated in FIG. 10B, the pressing unit 34b of the slider 34 moves to a position protruding from the intermediate transfer frame 25. Here the pressing unit 34b of the slider 34 contacts with the contacted surface 4a2 of the transfer bearing 4a, and pushes the transfer roller 4 against the spring force of the transfer spring 42. Then the transfer roller 4, which was pushed together with the transfer bearing 4a by the pressing unit 34b, is separated from the intermediate transfer belt 21. In Embodiment 2, this state is called a “separation state”.

When the roller separation mechanism 45 is in the separation state, the transfer spring 42 is compressed more than the contact state, resulting in generating a stronger spring force. When the open/close door 30 is closed in this state, the operating force required to close the open/close door 30 is larger than in the case of the contact state.

Therefore in Embodiment 2 as well, to prevent the change of the operating force of the open/close door 30 depending on the state of the roller separation mechanism 45, the control board 9 shifts the roller separation mechanism 45 to the contact state once opening of the open/close door 30 is detected. If the roller separation mechanism 45 is in the contact state when the open/close door 30 is opened, the control board 9 maintains this state. Therefore in the configuration of Embodiment 2 as well, the operating force required to close the open/close door 30 can be maintained as constant.

Embodiment 3 In Embodiments 1 and 2, the roller separation mechanism that is set for the transfer roller 4 was described. However use of the roller separation mechanism is not limited to the transfer portion. In Embodiment 3, operation when the roller separation mechanism is provided to the registration roller pair will be described. Description that is redundant with Embodiments 1 and 2 will be omitted.

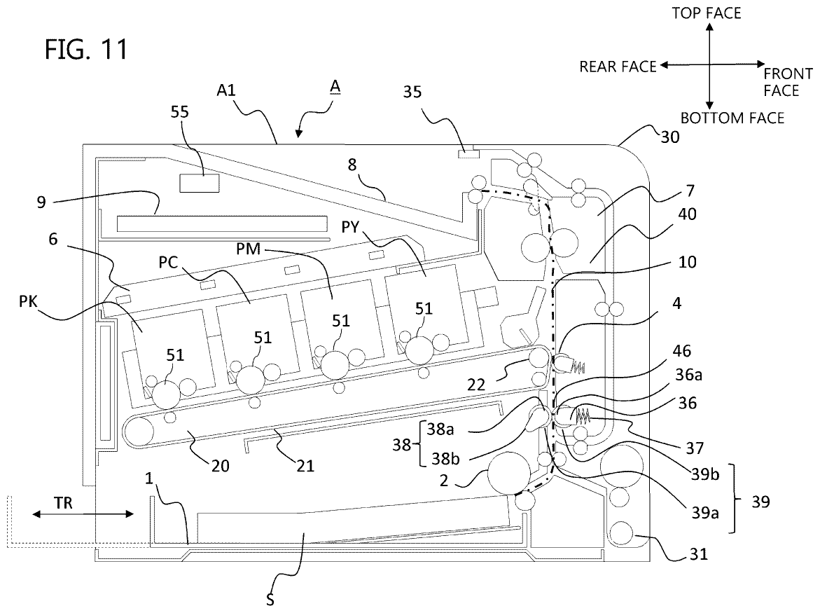

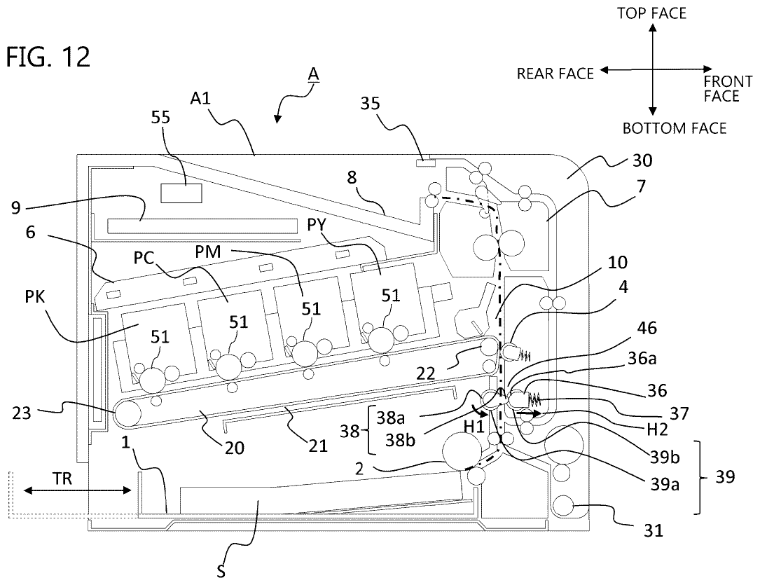

FIG. 11 and FIG. 12 indicate a configuration of a registration roller pair 39 of Embodiment 3. The registration roller pair 39 includes a registration bearing 36, a registration spring 37, a registration driver roller 39a, and a registration driven roller 39b. The registration driver roller 39a, is a rotating member which is rotatably supported by the frame of the image forming apparatus A, and is rotated by the drive force received from the motor 55. The registration bearing 36 is slidably supported by the open/close door 30. The registration driven roller 39b is a rotating member which is rotatably supported by the registration bearing 36, and is contacted with the registration driver roller 39a, so as to be rotated thereby. The registration spring 37 is provided between the registration bearing 36 and the open/close door 30, and press-contacts the registration driven roller 39b with the registration driver roller 39a at a predetermined pressing force by biasing the registration bearing 36 toward the registration driver roller 39a.

On the rotation shaft of the registration driver roller 39a, a separation cam 38 is supported to be rotatable around the rotation shaft. The separation cam 38 is integrated with a cam which is separable from the contacted surface 36a of the registration bearing 36, with gears (not illustrated) provided side-by-side in the rotation shaft direction. The gears are engaged with a drive source, which is different from the drive train of the registration driver roller 39a, and the separation cam 38 can rotate independently from the registration driver roller 39a. The roller separation mechanism 46 of Embodiment 3 includes at least the separation cam 38 and the registration bearing 36.

The roller separation mechanism 46 can be either in a contact state (see FIG. 11) where a coaxial portion 38a of the separation cam 38 faces the contacted surface 36a of the registration bearing 36, or in a separation state (see FIG. 12) where a protruding portion 38b of the separation cam 38 is in contact with a contacted surface 36a of the registration bearing 36.

In the contact state, the separation cam 38 and the registration bearing 36 are separated, and the registration driver roller 39a and the registration driven roller 39b are press-contacted at the pressing force of the registration spring 37. Therefore the registration roller pair 39 can convey the recording material S using the rotating force of the registration driver roller 39a and the pressing force of the registration driven roller 39b. The registration driver roller 39a is at a position where the pressing force from the registration driven roller 39b is received via the conveying path 10, that is, the registration driver roller 39a can be regarded as a receiving portion located in the conveying path 10.

In a case where an image forming operation is performed and the next image forming operation is not instructed even if a predetermined time elapsed thereafter, the roller separation mechanism 46 rotates the separation cam 38 (arrow H1). Then the roller separation mechanism 46 contacts the protruding portion 38b with the contacted surface 36a of the registration bearing 36, and pushes the registration bearing 36 (arrow H2), so as to separate the registration roller pair 39. In this state, the registration driven roller 39b is separated from the registration driver roller 39a, hence creep deformation and the like can be prevented.

The registration spring 37 is compressed more, that is, the spring pressure is higher, in the separation state than in the contact state. Therefore in the case where the registration roller pair 39 is in the separation state, the operating force required to close the open/close door 30 becomes higher than the case where the registration roller pair 39 is in the contact state.

Therefore in Embodiment 3, to prevent the change of the operating force to close the open/close door 30 depending on the state of the roller separation mechanism 46, the roller separation mechanism 46 is maintained in the contact state when the open/close door 30 is open. Therefore the control board 9 shifts the roller separation mechanism 46 to the contact state, once the opening of the open/close door 30 is detected when the roller separation mechanism 46 is in the separation state, just like Embodiments 1 and 2. On the other hand, if the roller separation mechanism 46 is in the contact state when the open/close door 30 is open, the control board 9 does not shift the state.

According to Embodiment 3, the operating force to close the open/close door 30 can be maintained as constant, hence the situation of incomplete closing when the user closes the open/close door 30 can be prevented, and user' confusion who views the notification that the door is open can be prevented.

The present disclosure provides a technique to prevent the force of the pressing member from becoming a resistance to close the open/close unit.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-167150, filed Sep. 26, 2024, which is hereby incorporated by reference herein in its entirety.

What is claimed is:

1. An image forming apparatus forming an image on a recording material which is conveyed through a conveying path, the image forming apparatus comprising:
an apparatus main body including a receiving portion located in the conveying path;
an open/close unit configured to be movable between an open position at which the conveying path is exposed to outside and a close position at which the conveying path is covered;
a roller provided to the open/close unit and configured to be located in the conveying path when the open/close unit is closed;
a pressure applying unit provided to the open/close unit and configured to apply pressure to the roller;
a separation unit provided to the apparatus main body, and configured to be movable between a first position and a second position, such that the roller contacts with the receiving portion and force of the pressure applying unit is received by the receiving portion in a case where the separation unit is at the first position, and the roller is held at a position separated from the receiving portion against the force in a case where the separation unit is at the second position;
a switching device configured to switch the position of the separation unit between the first position and the second position;
a control unit configured to control the switching device; and
an open/close detecting unit configured to detect an open/close state of the open/close unit, wherein
in a case where detection is made that the separation unit is at the second position and the open/close unit is at the open position, the control unit controls the switching device so that the separation unit is moved from the second position to the first position.

2. The image forming apparatus according to claim 1, wherein the receiving portion includes a rotating member which contacts with the roller.

3. The image forming apparatus according to claim 2, wherein
the rotating member is a transfer belt contactable with the recording material,
the receiving portion includes a counter roller configured to contact with an inner periphery of the transfer belt, and
in a case where the open/close unit is at the close position and the separation unit is at the first position, the roller is pressed toward the counter roller by the pressure applying unit.

4. The image forming apparatus according to claim 2, wherein
the rotating member is a conveying roller contactable with the recording material.

5. The image forming apparatus according to claim 1, wherein
the open/close unit includes an open/close door, and a frame unit which opens/closes in conjunction with the opening/closing of the open/close door and to which the roller and the pressure applying unit are provided.

6. The image forming apparatus according to claim 1, wherein
the pressure applying unit is a biasing member which is provided to the open/close unit and configured to bias the roller toward the receiving portion.

7. The image forming apparatus according to claim 6, wherein
in a state where the open/close unit is at the close position, a deformation amount of the biasing member, in a case where the separation unit is at the second position and the roller is separated from the receiving portion, is larger than a deformation amount of the biasing member in a case where the separation unit is at the first position and the roller is in contact with the receiving portion.

8. The image forming apparatus according to claim 1, wherein
the separation unit is a cam, and the switching device includes a drive source and a transfer member configured to transfer a drive force of the drive source to the separation unit.

9. The image forming apparatus according to claim 1, wherein
the separation unit is a slider, and the switching device includes a drive source and a transfer member configured to transfer a drive force of the drive source to the separation unit.

10. The image forming apparatus according to claim 1, wherein
in a case where closing of the open/close unit is detected and thereafter a predetermined time elapses without performing image forming operation, the control unit controls the switching device so that the separation unit is moved from the first position to the second position.

11. The image forming apparatus according to claim 1, wherein
the open/close detecting unit is a switch which is provided to the apparatus main body and configured to contact with a part of the open/close unit in a case where the open/close unit is closed.

12. The image forming apparatus according to claim 1, wherein
in a case where the open/close detecting unit detects that the open/close unit is open, the control unit notifies a user of this state.
